(19) United States
(12) Patent Application Publication
(10) Pub. No.: US 2020/0158017 A1
(43) Pub. Date: May 21, 2020

(54) VEHICLE MICROTURBINE SYSTEM AND METHOD OF OPERATING THE SAME

(71) Applicant: GM GLOBAL TECHNOLOGY OPERATIONS LLC, Detroit, MI (US)

(72) Inventors: Alberto Lorenzo Vassallo, Torino (IT); Gianmarco Boretto, Nichelino (To) (IT)

(21) Appl. No.: 16/193,038

(22) Filed: Nov. 16, 2018

(51) Int. Cl. F02C 6/20; F01N 9/00; F02C 9/16; F02C 3/04; F02C 3/14; F01N 3/035; F01N 11/00; B60K 6/24

(52) U.S. Cl. CPC F02C 6/20; F01N 9/002; F02C 9/16; F02C 3/04; F02C 3/14; F01N 3/035; B60Y 2400/431; B60K 6/24; F05D 2220/32; F05D 2220/76; F01N 2900/1406; F01N 2900/08; B60Y 2200/92; F01N 11/002

(57) ABSTRACT

A microturbine system for a vehicle and method of operating the microturbine system. The microturbine system is an automotive range extender that includes a generator to provide power to a battery pack of the vehicle. A compressor is operably coupled to the generator and a burner is operably coupled downstream of the compressor to burn fuel and heat compressed charge air from the compressor to form an exhaust. An aftertreatment device is operably coupled downstream of the burner to change a composition of the exhaust from the burner to form a treated exhaust. A turbine is operably coupled downstream of the aftertreatment device and operably coupled to the compressor. The turbine is configured such that a flow of the treated exhaust drives the turbine and the compressor to power the generator.

### INTRODUCTION

The field of technology generally relates to microturbine systems for vehicles, and more particularly, to microturbine systems used as range extenders in hybrid electric automotive vehicles.

Unlike standard piston-based internal combustion engines, a microturbine system includes a lighter, more compact arrangement in which a burner heats compressed air to drive a turbine, which can in turn, power a generator. Typical microturbine architectures can result in undesirable hydrocarbon/carbon monoxide emissions, solid particle emissions, and/or an odor during warm-up. For automotive applications, such as when the microturbine system is used as a range extender in a hybrid electric vehicle, it is advantageous to control potential hydrocarbon/carbon monoxide emissions, solid particle emissions, and/or odor during warm-up. Some control strategies include various burner optimization techniques, but integrating an aftertreatment device into the microturbine system, in applications such as low-emissions passenger cars, can help decrease emissions and avoid or lessen exhaust odor.

### SUMMARY

According to one embodiment, there is provided a microturbine system for a vehicle, comprising: a generator; a compressor operably coupled to the generator configured to intake charge air; a burner operably coupled downstream of the compressor, the burner includes a piston-less combustion chamber configured to burn fuel to heat the charge air that is compressed by the compressor to form an exhaust; an aftertreatment device operably coupled downstream of the burner configured to change a composition of the exhaust from the burner to form a treated exhaust; and a turbine operably coupled downstream of the aftertreatment device and operably coupled to the compressor. The turbine is configured such that a flow of the treated exhaust drives the turbine and the compressor to power the generator.

According to various embodiments, this system may further include any one of the following features or any technically-feasible combination of these features:
the aftertreatment device is a combined diesel oxidation catalyst (DOC) and diesel particulate filter (DPF);
the burner is configured to continuously combust during operation of the microturbine system to drive the generator;
a first pressure sensor and a second pressure sensor, wherein the first pressure sensor is operably coupled upstream of the aftertreatment device and the second pressure sensor is operably coupled downstream of the aftertreatment device;
an electronic control unit (ECU) is configured to obtain sensor readings from the first pressure sensor and the second pressure sensor, determine a pressure differential from the obtained sensor readings, and compare the pressure differential to a pressure differential threshold;
the aftertreatment device is actively regenerated when the pressure differential is greater than the pressure differential threshold;
an aftertreatment temperature sensor operably coupled downstream of the aftertreatment device, wherein an electronic control unit (ECU) is configured to obtain sensor readings from the aftertreatment temperature sensor to determine an aftertreatment temperature and compare the aftertreatment temperature to an aftertreatment temperature threshold;
the electronic control unit (ECU) is configured to reduce a speed of the compressor, reduce a speed of the turbine, or reduce the speed of the compressor and the speed of the turbine when the aftertreatment temperature is greater than the aftertreatment temperature threshold;
an electronic control unit (ECU) is configured to compare an air-fuel-ratio (AFR) to an AFR threshold;
the electronic control unit (ECU) is configured to reduce fuel or increase a speed of the compressor when the air-fuel-ratio (AFR) is less than the AFR threshold;
the electronic control unit (ECU) is configured to compare an aftertreatment temperature to an aftertreatment temperature threshold when the air-fuel-ratio (AFR) is greater than the AFR threshold; and/or
the vehicle is a hybrid electric automotive vehicle comprising a battery pack, and the generator is configured to provide power to the battery pack.

According to another embodiment, there is provided a microturbine system for a vehicle, comprising: a generator; a compressor operably coupled to the generator configured to intake charge air; a burner operably coupled downstream of the compressor configured to continuously combust during operation of the microturbine system to drive the generator by burning fuel to heat the charge air that is compressed by the compressor to form an exhaust; an aftertreatment device operably coupled downstream of the burner configured to change a composition of the exhaust from the burner to form a treated exhaust; a first pressure sensor and a second pressure sensor, wherein the first pressure sensor is operably coupled upstream of the aftertreatment device and the second pressure sensor is operably coupled downstream of the aftertreatment device; an aftertreatment temperature sensor operably coupled downstream of the aftertreatment device; a turbine operably coupled downstream of the aftertreatment device and operably coupled to the compressor, wherein the turbine is configured such that a flow of the treated exhaust drives the turbine and the compressor to power the generator; and an electronic control unit (ECU) configured to obtain sensor readings from the first pressure sensor, the second pressure sensor, and the aftertreatment temperature sensor and change a speed of the compressor depending on one or more of the obtained sensor readings.

According to another embodiment, there is provided a method of operating a microturbine system for a vehicle, the microturbine system including a generator, a compressor, a burner, an aftertreatment device, and a turbine, the method comprising the steps of: monitoring turbine-related parameters, wherein the turbine-related parameters include an air-fuel-ratio (AFR) and an aftertreatment temperature; comparing the AFR to an AFR threshold; reducing fuel or increasing a speed of the compressor when the AFR is less than the AFR threshold; comparing the aftertreatment temperature to an aftertreatment temperature threshold when the measured AFR is greater than the AFR threshold; and reducing the speed of the compressor, reducing a speed of the turbine, or reducing the speed of the compressor and the speed of the turbine when the aftertreatment temperature is less than the aftertreatment temperature threshold.

According to various embodiments, this method may further include any one of the following steps or features or any technically-feasible combination of these steps or features:
the step of maintaining a standard operating mode when the aftertreatment temperature is greater than the aftertreatment temperature threshold;
the aftertreatment device is a combined diesel oxidation catalyst (DOC) and diesel particulate filter (DPF);
the turbine-related parameters further include a pressure differential across the combined diesel oxidation catalyst (DOC) and diesel particulate filter (DPF);
the step of comparing the pressure differential to a pressure differential threshold; and/or
the step of actively regenerating the diesel particulate filter (DPF) when the pressure differential is greater than the pressure differential threshold.

### BRIEF DESCRIPTION OF THE DRAWINGS

Preferred exemplary embodiments will hereinafter be described in conjunction with the appended drawings, wherein like designations denote like elements, and wherein:

FIG. 1 is a schematic representation of a microturbine system for a vehicle according to one embodiment; and

FIG. 2 is a flowchart illustrating a method of operating a microturbine system, such as the microturbine system of FIG. 1.

### DETAILED DESCRIPTION

The system and method described herein relate to a microturbine system that strategically incorporates an aftertreatment device to reduce emissions in automotive applications, such as with hybrid electric vehicles that incorporate the microturbine system as a range-extender. The microturbine system can be advantageous in that it is typically lighter and more compact than the standard piston-operated internal combustion engine. The microturbine system described herein has an aftertreatment architectural layout, and can be operated in accordance with the methods described herein to help manage and/or achieve emissionization and odorless operation for automotive applications. In one embodiment, the aftertreatment device is a combined diesel oxidation catalyst (DOC) and diesel particulate filter (DPF). Emissionization strategies for the combined DOC and DPF include DOC warm-up and DPF active regeneration to achieve homologation and avoid exhaust odor.

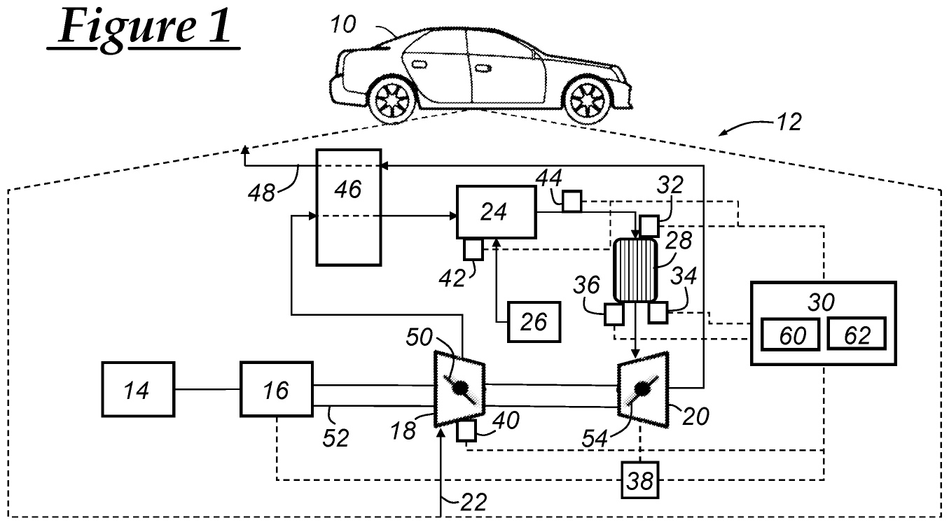

FIG. 1 a schematic representation of an example vehicle 10 equipped with microturbine system 12. It should be appreciated that the microturbine systems and methods described herein may be used with any type of automotive vehicle, including traditional passenger vehicles, sports utility vehicles (SUVs), cross-over vehicles, trucks, vans, buses, recreational vehicles (RVs), etc. These are merely some of the possible applications, as the microturbine system 12 and method described herein are not limited to the exemplary embodiment shown in the figures and could be implemented with any number of different vehicles.

In an advantageous embodiment, the vehicle 10 is a hybrid electric automotive vehicle that uses the microturbine system 12 as a range extender when use of a primary source of motive power, such as the battery pack 14, is unavailable, limited, or otherwise needs to be supplemented. The vehicle 10 may be a full hybrid, a mild hybrid, or a plug-in hybrid (PHEV), having any operable hybrid arrangement, such as series, parallel, or power split, for example. Accordingly, the battery pack 14 may be a high-voltage battery or an energy storage system. The battery pack 14 may receive power from a generator 16 of the microturbine system 12.

According to one embodiment, the generator 16 of the microturbine system 12 is operably connected to a compressor 18 and a turbine 20. The compressor 18 is configured to intake charge air via input 22. A burner 24 is operably coupled downstream of the compressor 18. The burner 24 is configured to burn fuel received from fuel injector 26 to heat the charge air that is compressed by the compressor 18 to form an exhaust. An aftertreatment device 28 is operably coupled downstream of the burner 24. The aftertreatment device 28 is configured to change a composition of the exhaust from the burner 24 to form a treated exhaust. The turbine 20 is operably coupled downstream of the aftertreatment device 28 and operably coupled to the compressor 18. The turbine 20 is configured such that a flow of the treated exhaust drives the turbine 20 and the compressor 18 to power the generator 16. Operation of the microturbine system 12 may be accomplished with an electronic control unit (ECU) 30. Various sensors and components may provide readings or information to the ECU 30 to operate the components of the microturbine system 12, including but not limited to, first and second pressure sensors 32, 34, an aftertreatment temperature sensor 36, and a turbine governor 38.

Any number of different sensors, components, devices, modules, systems, etc. may provide the microturbine system 12 with information, data and/or other input. These include, for example, the components shown in FIG. 1, sensors 32-38 listed above, as well as other sensors that are known in the art. For example, the system 12 may also include an airflow meter (AFM) 40, a fuel flow meter 42, and/or a lambda sensor 44. In some implementations, however, only some of the sensors described above are employed and/or used. Additionally, other sensors that are not shown in FIG. 1 may be used as well. For example, the system 12 may include extra temperature sensors, a fuel injection pressure sensor, or various battery sensors for the battery 14, to cite a few possibilities. It should be appreciated that the various components used by the microturbine system 12 may be embodied in hardware, software, firmware or some combination thereof. These components may directly sense or measure the conditions for which they are provided, or they may indirectly evaluate such conditions based on information provided by other sensors, components, devices, modules, systems, etc. Furthermore, these components may be directly coupled to the ECU 30, indirectly coupled via other electronic devices, a vehicle communications bus, network, etc., or coupled according to some other arrangement known in the art. These components may be integrated within another vehicle component, device, module, system, etc. (e.g., sensors that are associated a powertrain control module (PCM), an emissions control system, a fuel economy mode, etc.), they may be stand-alone components (as schematically shown in FIG. 1), or they may be provided according to some other arrangement. In some instances, multiple sensors might be employed to sense a single parameter (e.g., for providing redundancy). It should be appreciated that the foregoing scenarios represent only some of the possibilities, as any type of suitable arrangement or architecture may be used to carry out the methods described herein. For example, it is possible for the sensors and/or other components to be arranged in a different configuration.

The generator 16 is advantageously a motor/generator unit configured to supplement energy needs of the battery pack or energy storage system 14. Additionally or alternatively, it may be possible for the generator 16 to directly power the transmission and wheels of the vehicle 10. The generator 16 may be able to extend the range of the vehicle 10 between 1,000 and 1,500 km or more. A separate lower voltage battery (e.g., 12V) for powering various vehicle system modules and other components of the vehicle electronics may also be included as part of the battery pack or energy storage system 14. In one embodiment, the generator 16 provides power to an energy storage system 14 that includes a lithium-ion battery pack with a plurality of lithium-ion batteries and a separate lead acid battery. The generator 16 may receive or provide feedback from a number of different vehicle components, such as the ECU 30. For example, feedback from generator 16 may be used to regulate the microturbine power output, either directly via the ECU 30 or via another component such as the turbine governor 38.

The compressor 18 is operably connected to the generator 16 and helps force intake charge air from input 22 through a heat exchanger 46 toward the burner 24. The heat exchanger or recuperator 46 promotes more efficient thermal control by heating compressed charge air from the compressor 18 with treated exhaust heading toward exhaust output 48. The compressor 18 includes a plurality of compressor blades 50 and is mounted on a shaft with the generator 16 and the turbine 20. Other features such as bearings, different shafts, pumps, filters, etc. may be included to help facilitate operation of the compressor 18 or the turbine 20. An air-flow meter 40 may be associated with the intake 22 to the compressor 18 to provide information relating to the intake or charge air. The air-flow meter 40 may provide sensor readings used by ECU 30 to implement the operating methods described herein.

The turbine 20 in this embodiment is mounted on the same shaft 52 as the compressor 18 and the generator 16. However, it will be appreciated that other architectures are certainly possible, such as those that use a gearbox or the like to adjust the drive speed. The turbine 20 includes a plurality of turbine blades 54 which are driven by hot, treated exhaust from the burner 24 and aftertreatment device 28. In some embodiments, either the compressor 18, the turbine 20, or both the compressor 18 and the turbine 20 include a series of blades to more precisely control the volumetric distribution of air and/or exhaust traveling through the microturbine system 12. Additionally, either the compressor 18, the turbine 20, or both the compressor 18 and the turbine 20 may have a variable or fixed geometry, or include a waste gate. The turbine 20 advantageously is associated with a turbine governor 38, which in this embodiment, is a dedicated governor that controls the turbine load and regulates the power output of the microturbine system 12 via fuel injected with the fuel injector 26 to the burner 24.

The burner 24 includes a piston-less combustion chamber and is configured for continuous combustion when the microturbine system 12 is driving the generator 16. The burner 24 burns fuel from the fuel injector 26 to ignite charge air that is compressed by the compressor 18 and optionally heated with exhaust via heat exchanger 46. In an advantageous embodiment, diesel is burned by the burner 24, but other fuel sources or combinations of fuel sources are certainly possible. Sensors such as the fuel flow meter 42 and/or the lambda sensor 44 may be associated with the burner 24 or its intake or exhaust lines to provide information relating to the combustion process. Readings may be used by ECU 30 to carryout the operating methods described herein.

The aftertreatment device 28 treats exhaust from the burner 24. The aftertreatment device 28 may be any device that is configured to change the composition of the exhaust. Some examples include, but are not limited to, catalytic converters (two or three way), oxidation catalysts, lean NOx traps, hydrocarbon adsorbers, selective catalytic reduction (SCR) systems, and particulate filters. In the preferred embodiment, the aftertreatment device 28 is a combined diesel oxidation catalyst (DOC) and diesel particulate filter (DPF). In a more particular embodiment, the combined DOC and DPF includes a DOC with a 400 cpsi (cells per square inch) metallic or ceramic (e.g., cordierite) substrate and a DPF with a 300 cpsi ceramic (e.g., silicon carbide) substrate (e.g., a wall-flow filter). A flow-through combined DOC and DPF is desirable as it provides a high open frontal area. Either ceramic or metallic could be employed for the combined DOC and DPF, particularly if the filter can withstand high temperatures (up to 1000° C.) and has high permeability (e.g., a low pressure drop). Additionally, a non-wall-flow filter could be used (e.g., a filter without a cell-based structure such as a ceramic foam or other porous metallic filter). In some embodiments, the aftertreatment device 28 may not be a separate or stand-alone device, as it may be associated with another component of the system 12 such as the turbine 20.

The aftertreatment device 28 is strategically located directly downstream of the burner 24 and directly upstream of the inlet of the turbine 20. At this location, a metallic DOC with DPF functionality can be added with less of an impact on performance and efficiency. Furthermore, this location is more robust for passive operation, and more effective for light-off and active regeneration, as the temperature is the highest available for passive regeneration between the turbine 20 and the burner 24. Because the burner 24 usually outputs exhaust that has a higher temperature than a traditional piston engine, locating the combined DOC and DPF just downstream can result in more efficient attainment of the light-off temperature. Additionally, at this location, the volumetric flow rate is relatively low because of the high pressure before the turbine expansion, and the aftertreatment device 28 will thus minimally impact the expansion ratio, which would not necessarily be the case if the aftertreatment device 28 is placed at the turbine exhaust.

The ECU 30 controls various components of the microturbine system 12 in order to promote efficient usage of the aftertreatment device 28. Accordingly, the ECU 30 may obtain feedback or information from numerous sources, such as the first and second pressure sensors 32, 34 and the aftertreatment temperature sensor 36, and then control operation of components such as the compressor 18 and/or the turbine 20 based on various operating parameters that may be ascertained based on the sensor information. The ECU 30 may be considered a controller, a control module, etc., and may include any variety of electronic processing devices, memory devices, input/output (I/O) devices, and/or other known components, and may perform various control and/or communication related functions. In an example embodiment, ECU 30 includes an electronic memory device 60 that stores sensor readings (e.g., sensor readings from sensors 32-44), look up tables or other data structures (e.g., look up tables relating to calibratable turbine parameters described below), algorithms (e.g., the algorithm embodied in the method described below), etc. The memory device 60 may maintain a buffer consisting of data collected over a predetermined period of time or during predetermined instances (e.g., turbine parameters during engine start events). The memory device 60, or just a portion thereof, can be implemented or maintained in the form of an electronic data structure, as is understood in the art. ECU 30 also includes an electronic processing device 62 (e.g., a microprocessor, a microcontroller, an application specific integrated circuit (ASIC), etc.) that executes instructions for software, firmware, programs, algorithms, scripts, etc. that are stored in memory device 60 and may partially govern the processes and methods described herein.

Depending on the particular embodiment, the ECU 30 may be a stand-alone vehicle electronic module (e.g., an engine controller, a specialized or dedicated microturbine controller, etc.), it may be incorporated or included within another vehicle electronic module (e.g., a powertrain control module, an automated driving control module, etc.), or it may be part of a larger network or system (e.g., a fuel efficiency system where a supervising vehicle control unit directly controls the specific microturbine ECU), or it may be a slave control unit implementing low-level controls on the basis of a supervising vehicle control unit, to name a few possibilities. Accordingly, the ECU 30 is not limited to any one particular embodiment or arrangement and may be used by the present method to control one or more aspects of the microturbine system 12 operation. The microturbine system 12 and/or ECU 30 may also include a calibration file, which is a setup file that defines the commands given to the actuating components such as the compressor 18, the turbine 20, and/or the fuel injector 26. The commands govern the microturbine system 12 and may include, for example, the ability to alter a control signal to alter the speed of the compressor 18 and/or the turbine 20.

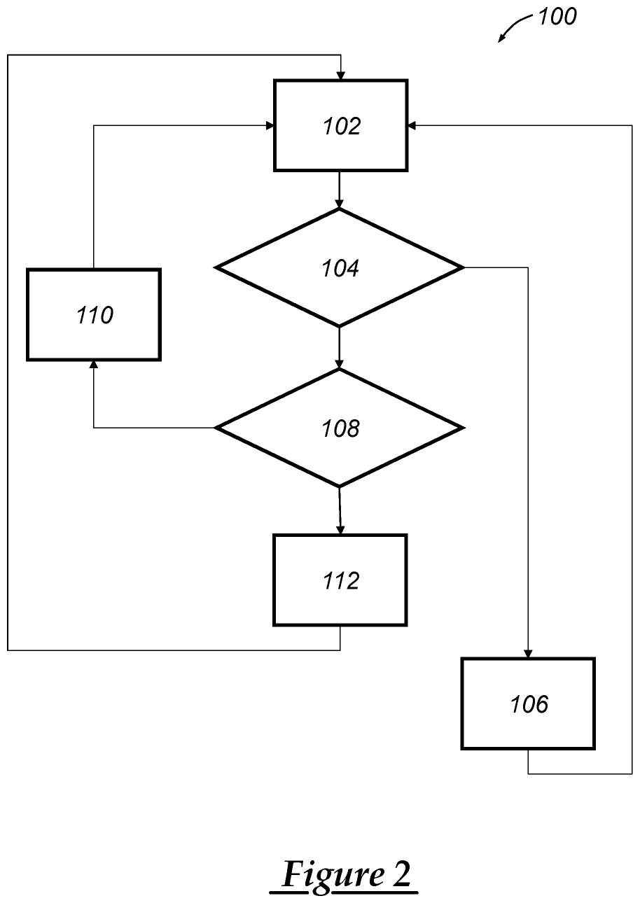

FIG. 2 illustrates a method 100 for operating a microturbine system using the system described above with respect to FIG. 1. It should be understood that the steps of the method 100 are not necessarily presented in any particular order and that performance of some or all the steps in an alternative order is possible and is contemplated. Further, it is likely that the method 100 could be implemented in other systems that are different from the system 12 illustrated in FIG. 1, and that the description of the method 100 within the context of the system 12 is only an example.

The method 100 begins at step 102, with monitoring turbine-related parameters. This step may be accomplished by receiving sensor input from sensors 32-44 at the ECU 30. In an advantageous embodiment, the turbine-related parameters include an air-fuel-ratio (AFR) and an aftertreatment temperature. The aftertreatment temperature may be obtained from the aftertreatment temperature sensor 36. The AFR may be obtained or calculated in a number of ways. For example, the lambda sensor 44 could be located at or near the inlet of the aftertreatment device 28 to measure AFR, and in such an embodiment, the lambda sensor 44 could be used for AFR control during active regeneration as well. In another example, the AFR may be obtained through combined utilization of the air flow meter (AFM) 40 placed at or near the inlet duct of the compressor 18 and the fuel flow meter 42 placed at or near the supply to the burner 24. Dividing the airflow reading by the fuel flow reading, which may be accomplished by the ECU 30, can provide the AFR. In yet another example, airflow and fuel flow can be estimated using a compressor map and RPM reading (a physical model) and fuel injector 26 energizing duty. This example would be an open-loop estimate and likely more cost effective than the other two examples as no additional sensors are required. In another advantageous embodiment, the turbine-related parameters include the load of turbine 20 or the power output of the turbine 20. This may be obtained based on feedback from the turbine governor 38. In some implementations, turbine 20 load control is accomplished through the dedicated governor 38, which regulates the microturbine power output via the fuel injected in the burner 24 in closed-loop, based on feedback from the motor-generator 16. Another turbine-related parameter includes a pressure differential across the aftertreatment device 28, which may be calculated by ECU 30 with readings obtained by first and second pressure sensors 32, 34. Other turbine-related parameters that may be monitored in step 102 can include the speed of the compressor 18 and/or turbine 20, the power output of the generator 16, or other operational parameters.

Step 104 of the method compares the AFR monitored in step 102 to an AFR threshold. In one embodiment, the AFR threshold is the minimum AFR required for operation of the burner 24. At this point, NOx and fuel deposit formation is likely. If the AFR is less than the minimum or threshold AFR, the method continues to step 106. It should be understood that recitations of comparing steps such as “less than” or “greater than” are open-ended such that they could include “less than or equal to” or “greater than or equal to,” respectively, and this will depend on the established parameter evaluations in the desired implementation. When the AFR is less than the threshold AFR, in step 106, the amount of fuel will be reduced (e.g., via fuel injector 26) or the speed of the compressor 18 will be increased. When the AFR is less than the threshold AFR, the AFR is being saturated to the minimum value acceptable for combustion efficiency. For most microturbine systems 12, this AFR may be about 1.2:1, however this may change depending on the specifications of the system. As addressed above, depending on the operating mode, either the fuel should be reduced or the compressor speed should be increased, with either option leading to a load reduction. After step 106, the method may return to step 102 to continue monitoring the turbine-related parameters.

If in step 104 it is determined that the AFR is greater than the minimum or threshold AFR, the method may continue to step 108. In step 108, the aftertreatment temperature monitored in step 102 is compared to an aftertreatment temperature threshold. In a particular embodiment, step 108 asks whether the temperature of the DOC (e.g., the aftertreatment temperature), as measured by the aftertreatment temperature sensor 36, is greater than a light-off temperature (e.g., the aftertreatment temperature threshold). The light-off temperature is the temperature at which passive regeneration of the aftertreatment device 28 is facilitated. Typical HC/CO light-off temperatures for emission reduction and odorless operation, according to one embodiment, is in the range of 130−200° C., and can depend on one or more parameters such as the DOC type and chemistry, aging, fuel type, etc. Accordingly, the aftertreatment temperature threshold can be a calibratable, dynamic threshold that takes into account one or more parameters.

Step 108 helps to ensure hydrocarbon (HC) and carbon monoxide (CO) emissions are controlled at startup and during warm-up, and can also provide odorless operation and reduced particle number (PN) emissions during these periods. With the microturbine system 12, NOx emissions are typically acceptable or even considerably low, since the system can operate about 6-7 times leaner than a diesel piston engine with comparable power. However, PN, HC, and CO emissions need to be controlled, particularly at startup or before the aftertreatment temperature threshold is met. The aftertreatment device 28, particularly when operated in conjunction with the method 100, can reduce the particulate matter and chemically change the composition of the exhaust output from burner 24.

If in step 108 it is determined that the aftertreatment temperature is greater than the aftertreatment temperature threshold, the method may continue to step 110. In step 110, a standard operating mode is maintained. The standard operating mode involves passive regeneration of the aftertreatment device 28. Passive regeneration is typically the most efficient operating mode for the aftertreatment device 28. Placing a combined DOC and DPF just downstream of the burner 24 can help promote usage of the standard operating mode and passive regeneration.

In step 110, the method may optionally provide active regeneration of the aftertreatment device 28, or more particularly, active regeneration of the DPF when maximum loading is achieved. Loading may be monitored by the ECU 30 using sensor readings from the first and second pressure sensors 32, 34. Accordingly, a pressure differential may be determined based on the sensor readings from the first and second pressure sensors 32, 34. This pressure differential may be compared to a pressure differential threshold to determine whether maximum loading is achieved. With the microturbine system 12, active regeneration is less likely, because the system 12 works so lean and hot. However, this optional aspect of step 110 may include specific calibratable temperature targets and durations in order to efficiently treat the exhaust from burner 24 when maximum loading is achieved. This optional aspect of step 110 may be carried out in accordance with the methods described in U.S. patent application Ser. No. 11/542,688 filed on Oct. 3, 2006, which is incorporated by reference in its entirety herein. After step 110, the method may continue the monitoring of step 102.

If in step 108 it is determined that the aftertreatment temperature is less than the aftertreatment temperature threshold, the method may continue to step 112. Step 112 involves reducing a speed of the compressor 18, reducing a speed of the turbine 20, or reducing the speed of both the compressor and the turbine. This will increase loading of generator 16. This can lower the AFR which can improve warm-up of the combined DOC and DPF aftertreatment device 28 until the light-off temperature target is reached. Because the output temperature of the burner 24, which is almost always operated lean, is a direct function of AFR, reducing overleaning of the mixture can help encourage fast warm-up of the aftertreatment device 28, depending on the embodiment, up to 130-200° C. for a light off temperature, or actively regenerate it up to about 500-650° C. Accordingly, particularly with a combined DOC and DPF, the emissionization strategy can include DOC warm-up and DPF active regeneration in order to achieve homologation and avoid or lessen exhaust odor. After step 112, the method may continue the monitoring of step 102.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

What is claimed is:

1. A microturbine system for a vehicle, comprising:
a generator;
a compressor operably coupled to the generator, wherein the compressor is configured to intake charge air;
a burner operably coupled downstream of the compressor, wherein the burner includes a piston-less combustion chamber configured to burn fuel to heat the charge air that is compressed by the compressor to form an exhaust;
an aftertreatment device operably coupled downstream of the burner, wherein the aftertreatment device is configured to change a composition of the exhaust from the burner to form a treated exhaust; and
a turbine operably coupled downstream of the aftertreatment device and operably coupled to the compressor, wherein the turbine is configured such that a flow of the treated exhaust drives the turbine and the compressor to power the generator.

2. The system of claim 1, wherein the aftertreatment device is a combined diesel oxidation catalyst (DOC) and diesel particulate filter (DPF).

3. The system of claim 1, wherein the burner is configured to continuously combust during operation of the microturbine system to drive the generator.

4. The system of claim 1, further comprising a first pressure sensor and a second pressure sensor, wherein the first pressure sensor is operably coupled upstream of the aftertreatment device and the second pressure sensor is operably coupled downstream of the aftertreatment device.

5. The system of claim 4, wherein an electronic control unit (ECU) is configured to obtain sensor readings from the first pressure sensor and the second pressure sensor, determine a pressure differential from the obtained sensor readings, and compare the pressure differential to a pressure differential threshold.

6. The system of claim 5, wherein the aftertreatment device is actively regenerated when the pressure differential is greater than the pressure differential threshold.

7. The system of claim 1, further comprising an aftertreatment temperature sensor operably coupled downstream of the aftertreatment device, wherein an electronic control unit (ECU) is configured to obtain sensor readings from the aftertreatment temperature sensor to determine an aftertreatment temperature and compare the aftertreatment temperature to an aftertreatment temperature threshold.

8. The system of claim 7, wherein the electronic control unit (ECU) is configured to reduce a speed of the compressor, reduce a speed of the turbine, or reduce the speed of the compressor and the speed of the turbine when the aftertreatment temperature is greater than the aftertreatment temperature threshold.

9. The system of claim 1, wherein an electronic control unit (ECU) is configured to compare an air-fuel-ratio (AFR) to an AFR threshold.

10. The system of claim 9, wherein the electronic control unit (ECU) is configured to reduce fuel or increase a speed of the compressor when the air-fuel-ratio (AFR) is less than the AFR threshold.

11. The system of claim 9, wherein the electronic control unit (ECU) is configured to compare an aftertreatment temperature to an aftertreatment temperature threshold when the air-fuel-ratio (AFR) is greater than the AFR threshold.

12. The system of claim 1, wherein the vehicle is a hybrid electric automotive vehicle comprising a battery pack, and the generator is configured to provide power to the battery pack.

13. A microturbine system for a vehicle, comprising:
a generator;
a compressor operably coupled to the generator, wherein the compressor is configured to intake charge air;
a burner operably coupled downstream of the compressor, wherein the burner is configured to continuously combust during operation of the microturbine system to drive the generator by burning fuel to heat the charge air that is compressed by the compressor to form an exhaust;
an aftertreatment device operably coupled downstream of the burner, wherein the aftertreatment device is configured to change a composition of the exhaust from the burner to form a treated exhaust;
a first pressure sensor and a second pressure sensor, wherein the first pressure sensor is operably coupled upstream of the aftertreatment device and the second pressure sensor is operably coupled downstream of the aftertreatment device;
an aftertreatment temperature sensor operably coupled downstream of the aftertreatment device;
a turbine operably coupled downstream of the aftertreatment device and operably coupled to the compressor, wherein the turbine is configured such that a flow of the treated exhaust drives the turbine and the compressor to power the generator; and
an electronic control unit (ECU) configured to obtain sensor readings from the first pressure sensor, the second pressure sensor, and the aftertreatment temperature sensor and change a speed of the compressor depending on one or more of the obtained sensor readings.

14. A method for operating a microturbine system for a vehicle, the microturbine system including a generator, a compressor, a burner, an aftertreatment device, and a turbine, the method comprising the steps of:
monitoring turbine-related parameters, wherein the turbine-related parameters include an air-fuel-ratio (AFR) and an aftertreatment temperature;
comparing the AFR to an AFR threshold;
reducing fuel or increasing a speed of the compressor when the AFR is less than the AFR threshold;
comparing the aftertreatment temperature to an aftertreatment temperature threshold when the measured AFR is greater than the AFR threshold; and
reducing the speed of the compressor, reducing a speed of the turbine, or reducing the speed of the compressor and the speed of the turbine when the aftertreatment temperature is less than the aftertreatment temperature threshold.

15. The method of claim 14, further comprising the step of maintaining a standard operating mode when the aftertreatment temperature is greater than the aftertreatment temperature threshold.

16. The method of claim 14, wherein the aftertreatment device is a combined diesel oxidation catalyst (DOC) and diesel particulate filter (DPF).

17. The method of claim 16, wherein the turbine-related parameters further include a pressure differential across the combined diesel oxidation catalyst (DOC) and diesel particulate filter (DPF).

18. The method of claim 17, further comprising the step of comparing the pressure differential to a pressure differential threshold.

19. The method of claim 18, further comprising the step of actively regenerating the diesel particulate filter (DPF) when the pressure differential is greater than the pressure differential threshold.
